(19) United States
(12) Patent Application Publication
(10) Pub. No.: US 2025/0336560 A1
(43) Pub. Date: Oct. 30, 2025

(54) PRODUCTION AND PURIFICATION OF LUTETIUM-177 USING ELECTROMAGNETIC SEPARATION AND CHROMATOGRAPHY

(71) Applicant: Nusano, Inc., Valencia, CA (US)

(72) Inventors: Richard W. Sisson, Hollday, UT (US); Melissa M. Daniels, Eagle Mountain, UT (US); Garrett N. Burnette, Salt Lake City, UT (US); Anh H. T. Nguyen Sorenson, Lehi, UT (US); Evgeny Tereshatov, Herriman, UT (US); Andrew J. Hunter, Salt Lake City, UT (US); Adam J. Samia, Salt Lake City, UT (US)

(21) Appl. No.: 19/192,128

(22) Filed: Apr. 28, 2025

Related U.S. Application Data
(60) Provisional application No. 63/640,156, filed on Apr. 29, 2024.

(51) Int. Cl. G21G 1/02; B01D 15/18; B01D 15/38; C01F 17/13; G21G 1/00

(52) U.S. Cl. CPC G21G 1/02; B01D 15/1867; B01D 15/3885; C01F 17/13; G21G 2001/0094

(57) ABSTRACT

Various embodiments include a method of producing purified lutetium-177. The method may include irradiating a target material containing lutetium-176 in a nuclear reactor, separating lutetium-177 from the irradiated target material using electromagnetic isotope separation, dissolving the separated lutetium-177 in an acidic solution, purifying the dissolved lutetium-177 using a series of chromatographic columns and ion resins, and eluting the purified lutetium-177 in a final chemical form suitable for medical use. The chromatographic columns may include a first column containing a lanthanide resin and a second column containing a diglycolamide resin. The final chemical form may be lutetium-177 chloride.

### CROSS-REFERENCE TO RELATED APPLICATIONS

This application claims the benefit of priority to U.S. Provisional Application No. 63/640,156 titled “Systems and Methods for Lu-177 Isotopic Production and Separation,” filed Apr. 29, 2024, which is hereby incorporated by reference in its entirety for all purposes.

### BACKGROUND

Lutetium-177 is a radioisotope of increasing interest in the field of nuclear medicine, particularly for targeted radionuclide therapy. This beta-emitting isotope has physical properties that make it well-suited for treating various types of cancer. Its relatively short half-life of 6.64 days allows for sufficient time for pharmaceutical preparation and administration while minimizing long-term radiation exposure to patients.

Past production and purification of lutetium-177 has involved multiple steps, including neutron irradiation of a target material, isotope separation, and chemical processing. Electromagnetic isotope separation and chromatographic techniques are among the methods utilized to isolate and purify lutetium-177 from other isotopes and chemical impurities. These processes aim to produce lutetium-177 with high specific activity and radionuclidic purity, which are important factors for its effectiveness in medical applications.

### BRIEF DESCRIPTION OF THE FIGURES

The accompanying drawings, which are incorporated herein and constitute part of this specification, illustrate exemplary embodiments of the claims, and, together with the general description given and the detailed description, serve to explain the features herein.

FIG. 1 is a process flow diagram of a method for producing and purifying lutetium-177, according to various embodiments.

FIG. 2 is a process flow diagram for producing and processing desired isotope materials (e.g., Lu-177) according to various embodiments.

FIG. 3 is a process flow diagram of a method for isotope separation according to various embodiments.

FIGS. 4A and 4B are process flow diagrams of two alternative methods for purifying lutetium-177 according to some embodiments.

FIG. 5 is a system block diagram of a purification system suitable for purifying collected lutetium-177 according to some embodiments.

FIGS. 6A and 6B are block diagrams illustrating fluid flows through chromatographic columns through four stages of purifying lutetium-177 according to two alternative embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments provide systems and methods for producing and purifying lutetium-177 for use in targeted radionuclide therapy. Various embodiments include irradiating a target material containing lutetium-176 in a nuclear reactor, separating lutetium-177 using electromagnetic isotope separation, and purifying the separated lutetium-177 through a series of chromatographic columns. This process is expected to yield high-purity lutetium-177 suitable for medical applications.

The purification process in various embodiments utilizes a combination of lanthanide-specific and diglycolamide resins in sequential chromatographic columns. This approach, coupled with carefully controlled acid concentrations and air-drying steps, allows for efficient separation of lutetium-177 from other isotopes and chemical impurities.

Various embodiments provide improvements to radioisotope production and purification technologies by increasing the yield and purity of lutetium-177 while reducing processing time and complexity compared to traditional indirect production methods. The resulting high-specific activity, non-carrier-added lutetium-177 is well-suited for use in targeted cancer therapies and other medical applications.

Current methods for producing lutetium-177 often rely on indirect production routes that involve irradiating ytterbium-176 to produce ytterbium-177, which then decays to lutetium-177. This approach, while capable of producing high specific activity lutetium-177, is limited by the availability of highly enriched ytterbium-176 and the complexity of chemical separation processes. Direct production methods using lutetium-176 targets can potentially yield higher quantities of lutetium-177, but often result in lower specific activity due to the presence of inactive lutetium isotopes that cannot be chemically separated.

Various embodiments provide systems and methods for producing and purifying lutetium-177 for use in targeted radionuclide therapy. The process may include irradiating a target material containing enriched lutetium-176 in a nuclear reactor, separating lutetium-177 using electromagnetic isotope separation processes, and purifying the separated lutetium-177 through a series of chromatographic columns and chemical processing steps. This approach may yield high-purity lutetium-177 suitable for medical applications.

In some embodiments, the purification chromatographic columns and chemical processing steps utilize a combination of lanthanide-specific and diglycolamide resins in sequential chromatographic columns. This approach, coupled with carefully controlled acid concentrations and air-drying steps, may allow for efficient separation of lutetium-177 from other isotopes and chemical impurities.

The production and purification process provides improvements to radioisotope production technologies by potentially increasing the yield and purity of lutetium-177 while reducing complexity compared to traditional indirect production methods. The resulting high-specific activity lutetium-177 may be well-suited for producing economically feasible quantities useful in targeted cancer therapies and other medical applications.

In some embodiments, the target material may include a mixture of lutetium isotopes resulting from the irradiation of enriched lutetium-176 with thermal neutrons in a nuclear reactor. The electromagnetic isotope separation process may involve vaporizing the irradiated target material, ionizing the vaporized material, accelerating the ions, and separating lutetium-177 ions from other ions using a velocity filter that redirects ion beams based on their mass, velocity, and ionic charge interacting with electromagnetic fields. Desired isotope ions, such as lutetium-177 ions, may then be isolated from other isotopes and elements via selection orifices and collection chambers. Systems and operational methods for performing electromagnetic separation of isotopes, including separating lutetium-177 from lutetium-176, are described in U.S. patent application Ser. No. 19/192,062, entitled “Isotope Separation System With Velocity Filter” that is filed on the same day as this application, which is hereby incorporated by reference in its entirety for the disclosure of such systems and methods.

The process to purify the desired isotope, such as lutetium-177, after electromagnetic separation may involve dissolving the separated lutetium-177 in an acidic solution, such as nitric acid. The dissolved lutetium-177 may then be passed through a first chromatographic column containing a lanthanide resin, followed by a second chromatographic column containing a diglycolamide resin. In some cases, air may be passed through the chromatographic columns between elution steps to remove residual liquid. In some embodiments, reverse-direction flow may be used as part of this process. Because the electromagnetic separation process separates isotopes based on their mass, which results in different velocities of isotope ions passing through the velocity filter, the largest potential source of contamination may be isotopes with the same isotopic mass (i.e., same total number of protons plus neutrons). Chemical purification after isotopic separation can be effective due to the difference in chemistry of different elements represented by isotopes with the same isotopic weight.

The final product may be eluted in a chemical form suitable for medical use, such as lutetium-177 chloride. This process may involve carefully controlled concentrations of nitric acid and hydrochloric acid at various stages to optimize separation and purification.

In some embodiments, the production and purification system may include an electromagnetic isotope separator for separating a desired isotope from a source material that has been irradiated in a nuclear reactor, a dissolution chamber, a series of chromatographic columns, and a collection vessel. The system may also include one or more pumps configured to pass specific concentrations of acids through the columns and an air pump to remove residual liquid between elution steps. In some embodiments, a single pump containing four independent channels may be used to pass all acids and air through the system, with valves positioned to isolate and connect acid and air sources as needed to perform the various chemical processing operations.

This combined electromagnetic separation and chemical purification approach to lutetium-177 production and purification may offer advantages in terms of yield, purity, and efficiency compared to existing methods. The process may be particularly well-suited for producing high-quality lutetium-177 for medical applications on an industrial scale.

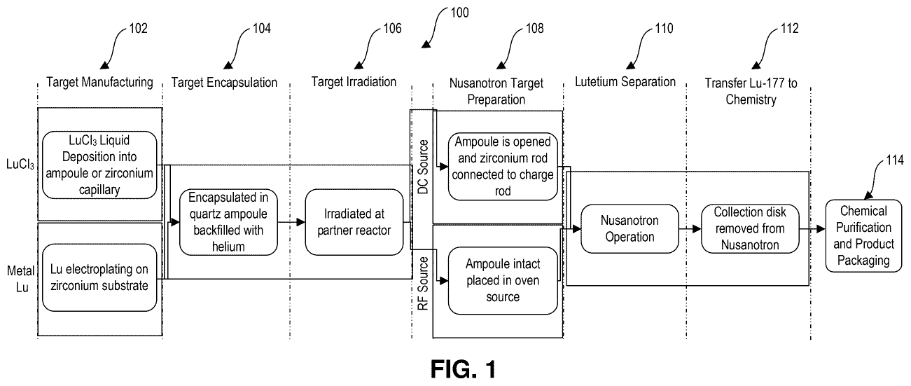

FIG. 1 illustrates a flowchart of an overall method 100 for producing and purifying lutetium-177. The method 100 includes several steps that encompass the entire process from target material manufacturing to final chemical purification.

In step 102, a target material containing lutetium-176 may be manufactured. In some embodiments, the target material may include enriched lutetium-176 metal that is applied through plating or other deposition methods onto a zirconium substrate. The use of enriched lutetium-176 as the target material may increase the yield of lutetium-177 during the subsequent neutron irradiation process. Zirconium is a preferred substrate material due to its high melting and sublimation temperatures and its low neutron absorption cross-section and activation.

In some embodiments, the target material may be prepared by electroplating lutetium onto a zirconium substrate. Electroplating may offer several advantages over other deposition methods such as sputtering or evaporating lutetium chloride. The electroplating process may be more cost-effective, provide better yield with less mass loss, and can typically be performed at room temperature without requiring high temperatures or exotic processes. The electroplating process may involve using a 10-volt power supply in an inert argon environment at room temperature. Dimethyl sulfoxide (DMSO) may be used as the solvent, and the reaction may be carried out for approximately 24 hours. In some cases, the process may be completed within an hour.

Using this electroplating method, deposition of up to 1 milligram of lutetium per square centimeter may be achieved on zirconium rods. To increase the plated surface area and achieve higher deposition amounts, a zirconium mesh substrate may be used instead of zirconium rods. When using zirconium mesh, the deposition amount may be increased to between 15 to 22 milligrams of lutetium due to the larger surface area of the substrate. This electroplating approach may allow for efficient and controlled deposition of lutetium onto the target substrate, potentially improving the overall yield and quality of the target material for subsequent irradiation and isotope production steps.

In step 104, the target material may be prepared for irradiation by enclosing it in a suitable container or capsule that can withstand the conditions inside a nuclear reactor. Typically, targets for neutron exposure in a nuclear reactor are encapsulated in a quartz ampoule backfilled with helium. Quartz ampoules may be used due to their minimal activation products when exposed to neutron irradiation. The ampoules may be flame sealed and undergo helium leak checking to ensure proper containment. In some cases, the target material may be free-floating within the ampoule. This encapsulation process may help protect the target material during irradiation while allowing for efficient neutron exposure. The use of helium as a backfill gas may provide improved heat transfer and inert atmosphere within the sealed ampoule. In some implementations, the target material may be deposited into the ampoule or a zirconium capillary prior to encapsulation. The encapsulated target may then be placed in a quartz ampoule backfilled with helium to create a double containment system. This approach may enhance safety and containment during irradiation and subsequent handling. The use of quartz for both the inner and outer ampoules may minimize activation and simplify post-irradiation processing.

In step 106, exposure of the target to a flux of thermal neutrons may occur in a nuclear reactor. During this step, lutetium-176 atoms that absorb a neutron are transformed into lutetium-177 isotopes through neutron capture reactions. Most such transformation reactions result in lutetium-177 isotopes; however, a fraction result in the metastable lutetium-177 isotope Lu-177m. In some implementations, such neutron irradiation may be conducted for five to seven days to achieve a sufficient amount of the lutetium-177 isotope for further processing.

After removal from the nuclear reactor, in step 108, the target may undergo preparation for isotope separation. This step may involve cooling the irradiated target, shipping the target in proper radiation shielding containers, removing the target from such shipping containers, extracting the target from the container or capsule, and preparing the target for the subsequent separation process.

In step 110, the prepared target material may undergo lutetium separation using electromagnetic isotope separation. This process may involve vaporizing the irradiated target material, ionizing the vapor, accelerating the ions, and using electromagnetic fields to separate lutetium-177 from other isotopes and elements present in the irradiated target. The separation may be performed using a device called a Nusanotron, which may operate for up to 5 days depending on the mass of the target. During operation, the Lu-177 may deposit onto a graphite disk in the collection chamber. The Nusanotron may incorporate either a DC source or an RF source. When using the DC source, a zirconium rod may be inserted into the charge rod, which may require a shielded glovebox and specialized tools to keep hands away from the target. The RF source may include an ampoule cracker that breaks the encapsulation within the Nusanotron after operation start-up. In some cases, using LuCl₃ with the DC source may limit the target mass that can be used to the amount that fits within a zirconium capillary. The interior of the Nusanotron chambers may be covered with liners to collect lutetium material that is not plated onto the collection disk. These liners may be periodically removed to manage long-lived Lu-177m that may build up in the system. Both LuCl₃ and metal lutetium may be ionized at approximately 1700° C. in the Nusanotron. The electromagnetic separation process may provide efficient isolation of Lu-177 from other isotopes and elements (except elements with mass number 177) present in the irradiated target material.

In step 112, the separated lutetium-177 may be transferred to the system for chemical processing. This transfer process may involve removing the graphite collection disk containing the Lu-177 from the Nusanotron into a shielded cask. The collection cask may then be transported to a chemistry processing cell where final product dissolution and polishing begins. This transfer step may be designed to safely move the radioactive material from the separation equipment to the purification area while maintaining containment and minimizing radiation exposure to personnel. The use of a shielded cask during transport may help protect workers from radiation and prevent contamination. The chemistry glovebox may provide a controlled environment for subsequent chemical processing steps, allowing for safe handling of the radioactive material during dissolution and purification procedures.

In step 114, the separated lutetium-177 may undergo chemical purification to remove impurities and produce the final product as described in more detail herein. This step may involve dissolving the separated lutetium-177 in an acidic solution and purifying the dissolved lutetium-177 using a series of chromatographic columns as described herein. In some embodiments, the final product may be eluted in a chemical form suitable for medical use, such as lutetium-177 chloride. This step may also include product packaging for shipment to a user of the isotope.

The method 100 may be implemented using a system that includes various components corresponding to the different steps of the process. A nuclear reactor may be used to irradiate a target material containing lutetium-176. In some embodiments, the system may include an electromagnetic isotope separator configured to separate lutetium-177 from other isotopes in the irradiated target material, a dissolution chamber configured to dissolve the separated lutetium-177 in an acidic solution, a series of chromatographic columns configured to purify the dissolved lutetium-177, and a collection vessel configured to receive purified lutetium-177 in a final chemical form suitable for medical use.

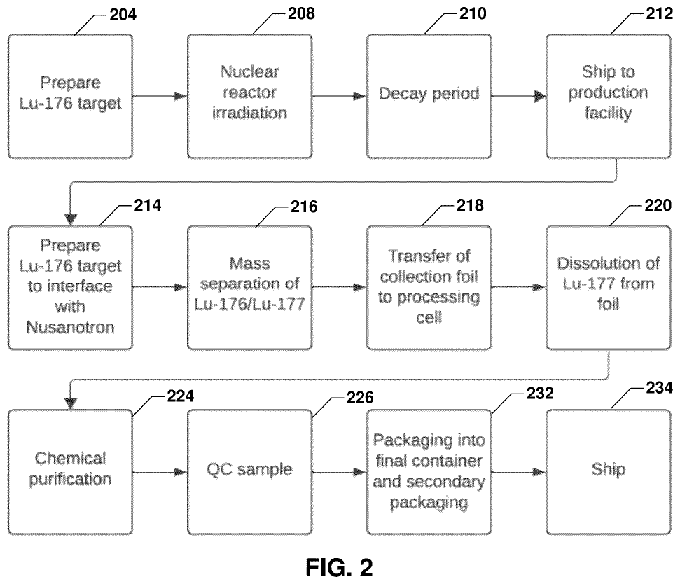

FIG. 2 is a flowchart of a process 200 that includes more details on the steps and materials involved in producing and processing desired isotope materials such as lutetium-177.

In block 204 a Lu-176 target may be prepared for irradiation. In some embodiments, the target may be enriched lutetium-176 that is received in oxide form and converted into a form for application to a target substrate, such as zirconium, and applied to the substrate by plating, sputtering, or evaporative deposition (e.g., of a LuCl₃ solution applied to the substrate). As described above, the form may be lutetium metal for using sputter, or a ionic solution (e.g., LuCl₃) for plating or evaporative deposition. As part of preparing it for irradiation, the target may be encapsulated in an ampoule suitable for insertion in a nuclear reactor.

In block 208, the ampoule with enclosed target is inserted into a reactor and exposed to a neutron flux for 5-6 days.

In block 210, the target is allowed to decay for a period of time (e.g., 1-3 days) after irradiation to enable short half-life activation products to decay. This decay reduces the amount of radiation that must be shielded during shipping to the separation and purification facility.

In block 212, the target is shipped to the separation and purification facility.

In block 214, the target is unpacked from shipping and prepared for insertion into the electromagnetic separation system.

In block 216, mass separation of lutetium-177 from lutetium-176 (as well as other isotopes and elements) is performed using an electromagnetic separation system in which the Lu-177 is collected on a collection surface or collection foil.

In block 218 the collection surface or foil, including the separated lutetium-177, is transferred to a glovebox or similar location for processing.

In block 220 the lutetium-177 on the collection surface is dissolved in an acid solution. In some embodiments, the acid may be hydrochloric acid (HCl), while in other embodiments, the acid may be nitric acid (HNO₃).

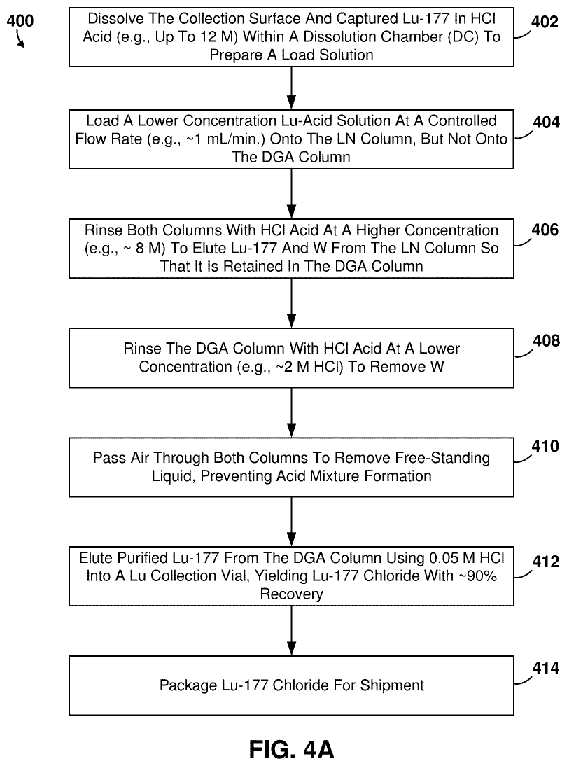

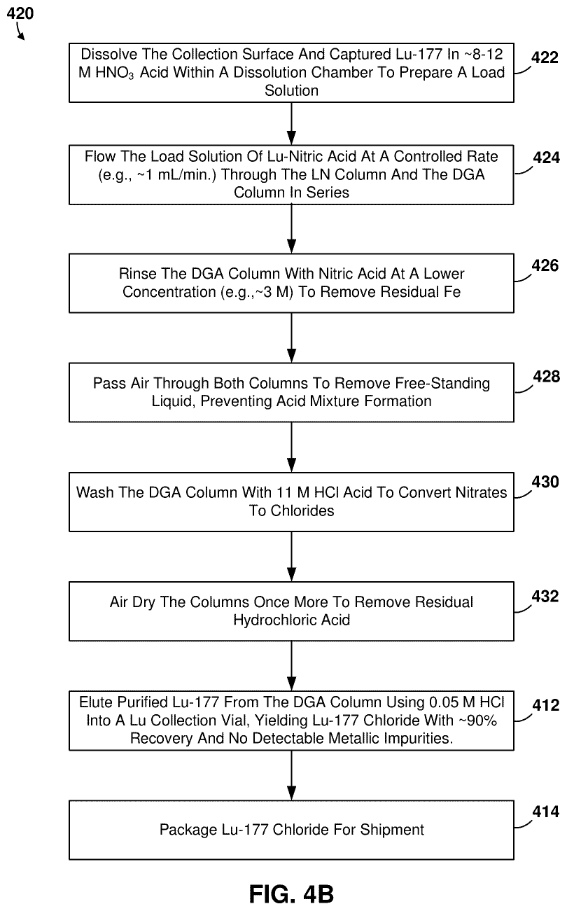

In block 224, a chemical purification process may be performed to purify lutetium-177 and produce a final product of lutetium-177 chloride (e.g., a LuCl₃ solution), such as the purification process described in detail with reference to FIGS. 4-6.

In block 226, a quality control sample of the purified lutetium-177 solution may be collected for analysis.

In block 232, operations of evaporation and reconstitution may be performed to further refine the lutetium-177 material, and the final form of material may be packaged for shipping in an appropriate radioactive material shipping container and secondary packaging, and shipped to the customer on block 234.

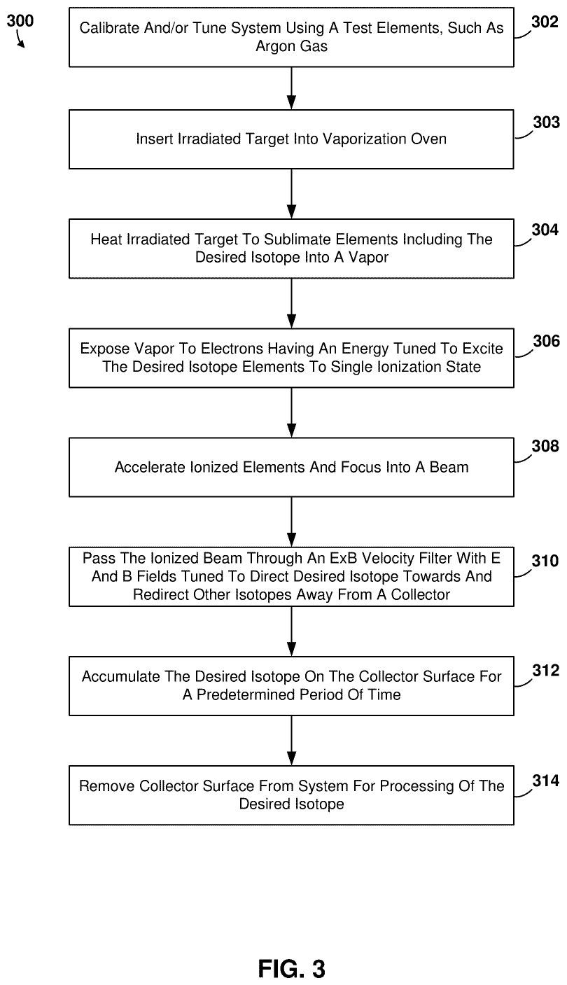

FIG. 3 is a flowchart of a method 300 of isotope separation using electromagnetic techniques performed in an isotope separation system. The method 300 may include several operations involved in isolating one or more desired isotopes, such as lutetium-177, from a source material, such a source including lutetium-176, lutetium-177, other isotopes of lutetium, and other elements, such as contaminant metals (e.g., copper, iron, zinc, etc.).

In block 302, the isotope separation system may be calibrated and/or tuned using test elements, such as argon or xenon gas. This calibration process may involve adjusting various voltage and power setting parameters of the isotope separation system components, reviewing data from system instrumentation, and making adjustments to system operating parameters until acceptable system performance is demonstrated.

In block 303, an irradiated target may be inserted into a vaporization oven. The irradiated target may contain the source material from which the desired isotope will be separated. For example, the target may be a rod or rolled up mesh of zirconium onto which a layer of lutetium has been plated (or otherwise deposited). This operation in block 303 may include evaluating the isotope separation system to a level of vacuum suitable for operations. In some embodiments, the operations in block 303 may be performed before the operations in block 302 to enable a vacuum to be established in the isotope separation system before calibration and operations to begin without the need for reestablishing vacuum conditions.

In block 304, the irradiated target may be heated to sublimate or evaporate elements, including the desired isotope (e.g., Lu-177), to form a vapor. The heating process may be controlled to achieve the desired vaporization or sublimation rate to support the overall isotope process.

In block 306, the vapor may be exposed to electrons having an energy tuned to excite the desired isotope elements to a single ionization state. For example, when the desired isotope is lutetium-177, the voltages on a cathode chamber where electrons are produced and an anode near the oven may be set to provide a differential voltage that accelerates electrons to approximately 40 electron volts. This energy level may be optimal for single-ionization of lutetium atoms while minimizing the production of double-ionized lutetium atoms. In some embodiments, the electrons may be directed to interact with and ionize vapor atoms within a reaction volume that is between the oven and the electron-producing cathode.

In block 308, the ionized elements may be accelerated and focused into a beam using shaped and tuned electric fields. This process may involve the use of an injector assembly and its components, such as an accelerator cathode, ground plate electrode, and an Einzel lens of coaxial cylindrical electrodes.

In block 310, the ionized beam may pass through a velocity filter in which perpendicular electric and magnetic fields are tuned to direct ions of the desired isotope towards and redirect other isotopes away from a selection collimator or other selection mechanism that is part of a collector assembly. In some embodiments, the ion velocity filter may be used for separating lutetium-177 ions from ions of lutetium-176 and other isotopes based on different velocities of the beams of the two isotopes, which result in different forces acting on the ions by the electric and magnetic fields within the filter. The use of a velocity filter to separate isotopes based on their different masses may provide flexibility and adjustability in the isotope separation process because the redirection of isotope beams can be controlled by adjusting the electric and magnetic fields within the velocity filter.

In some embodiments, the system may include a first turning magnet assembly to redirect the ion beam before entering the velocity filter. Additionally, the system may include a second turning magnet assembly to redirect the ion beam before entering the isotope collection module. These turning magnet assemblies may allow for a more compact system design or improved beam control.

In block 312, the desired isotope (e.g., Lu-177) may be accumulated on a collector surface for a predetermined period of time. The ion collection surface may be in the form of a high-purity graphite plate, carbon foil, carbon felt, or carbon fiber mesh that is stable at high temperatures, provides thermal cooling, is chemically inert, and compatible with purification processes.

In block 314, the collector surface may be removed from the isotope separation system after a sufficient amount of the desired isotope has been collected on the collection surface for a production run. The collection surface and its holder may be positioned in a shielded removal cask to move the radioactive isotope to a processing cell. From there, the desired isotope may be extracted from the collector material, such as by dissolving the isotope material in an acid as described in the method 400 with reference to FIG. 4.

The electromagnetic isotope separation process in method 300 may provide an efficient means of isolating lutetium-177 from other isotopes present in the irradiated target material. By carefully controlling the vaporization, ionization, and separation stages, the process may yield high-purity lutetium-177 suitable for subsequent chemical purification and medical use.

Further, the electromagnetic isotope separation process in method 300 enables the lutetium-177 isotope to be collected at a predetermined amount per day. In some embodiments, the isotope isolation system may operate at a beam current of approximately 12.7 microamps to produce ˜20-21 curies of lutetium-177 within a 24-hour period. This specific operating condition may allow for consistent and controlled production of the amount of desired isotope that can be consumed at a commercially acceptable rate based customer usage requirements and restrictions. Since lutetium-177 has a relatively short half-life, medical uses of the isotope require regular shipments as the material cannot be readily stockpiled. Thus, the processes of various embodiments are designed around providing regular periodic production and deliveries to users of specific amounts of the desired isotope, rather than the production of large batches that would require storage between uses.

FIGS. 4A and 4B are process flow diagrams of methods 400 and 420 for chemically purifying lutetium-177 after it has been isolated from the initial target material by the method 300 described above. Both methods use two chromatographic columns through which acid solutions can be flowed individually or together. The first chromatographic column contains approximately 100 mg of a lanthanide-specific (LN) ion resin. The second chromatographic column contains approximately 100 mg of a diglycolamide (DGA) resin. Both columns may have a size on the order of 4 mm by 20 mm. Alternatively, the chromatographic columns for both resins may be commercially available columns of a size and volume (e.g., a quarter mL (QML) size) that is consistent with processing a given amount of the desired isotope in a single batch. As noted above, the production and thus the purification processing of short-lived isotopes like lutetium-177 need to be sized to the usage or acceptance rate of medical isotope users. Thus, the size and configuration of the chemical processing components and system may be based on the desired consistent production rate for such isotopes.

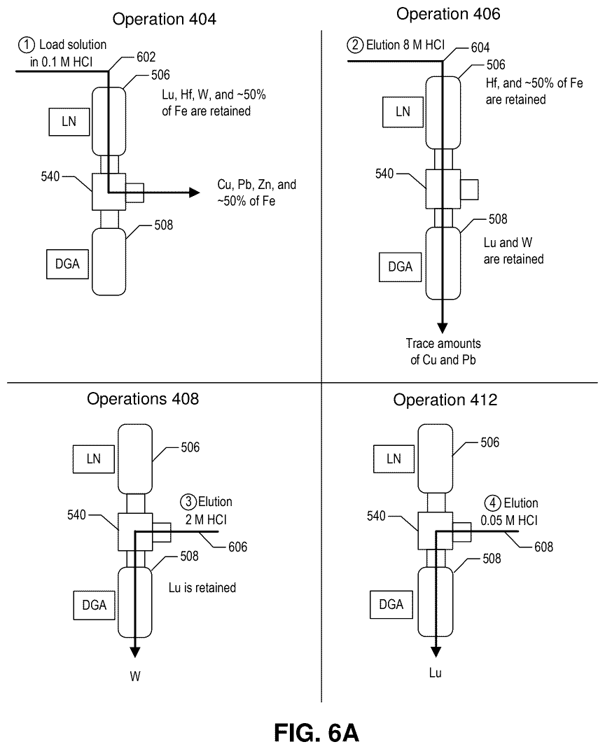

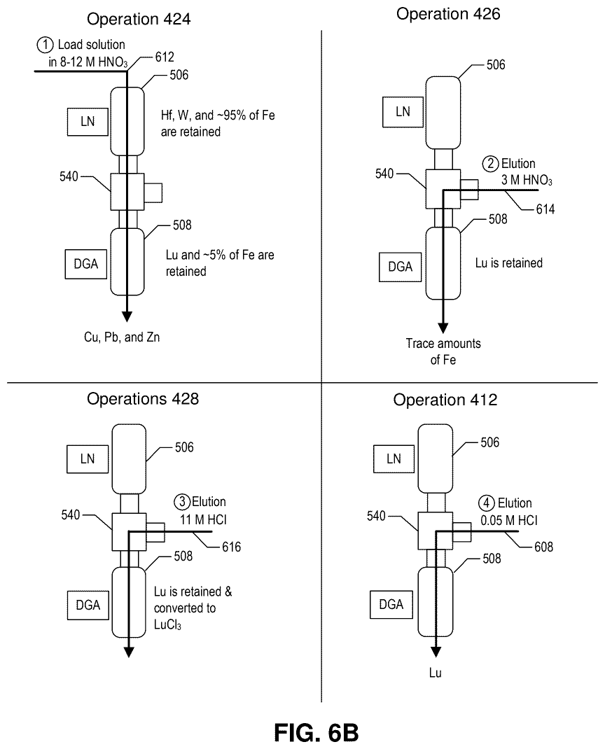

Two embodiment processes 400, 420 are contemplated and described individually with reference to FIGS. 4A and 4B. In a first embodiment method 400, described with reference to FIGS. 4A and 6A, only hydrochloric acid (HCl) is used in the load and elution solutions. In a second embodiment, described with reference to FIGS. 4B and 6B, nitric acid (HNO₃) is used in initial loading and elution operations, and hydrochloric acid is used in converting lutetium nitrate to lutetium chloride and elute the lutetium to the product collection container. These two embodiments are addressed in the alternative examples of acids mentioned in the following operation descriptions.

Referring first to FIG. 4A, the method 400 makes use of hydrochloric acid in various concentrations to selectively isolate lutetium from contaminants using LN and DGA resins.

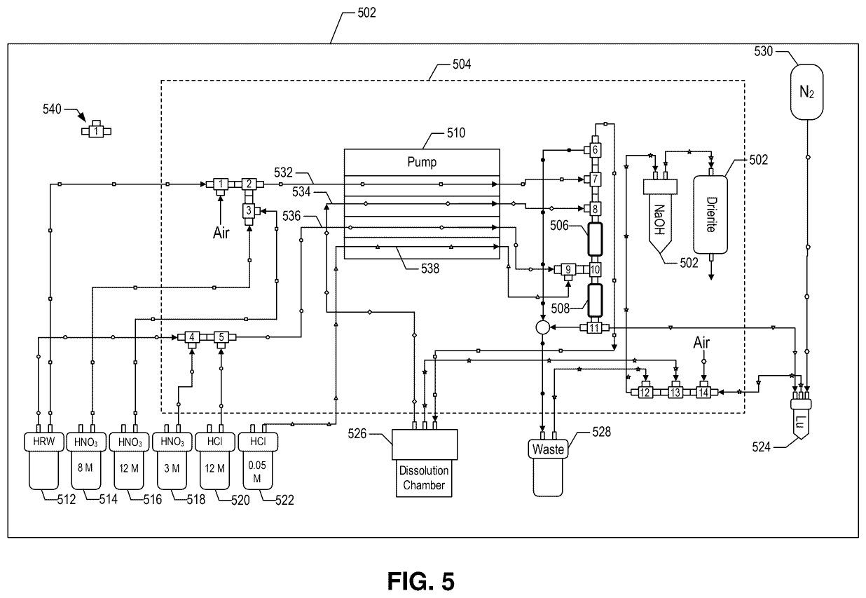

In block 402, the collection surface including the captured lutetium-177 may be dissolved in hydrochloric acid (e.g., up to 12 M) within a dissolution chamber to prepare a load solution. In some embodiments, the dissolution chamber may be part of an integrated purification system as illustrated in FIG. 5 that includes a pump (e.g., a peristaltic pump 510) and an acid vapor trap to manage potentially corrosive vapors.

In block 404, the solution including dissolved lutetium and any contaminants may be loaded onto the LN resin in the first chromatographic column but not onto the DGA resin in the second chromatographic column. The acid concentration of the hydrochloric acid solution loaded onto the LN column in block 404 may be less than the concentration used in block 402 to dissolve the lutetium. For example, the hydrochloric acid of the load solution may have a first acid concentration of up to 1 M (e.g., ˜0.1 M), which is a concentration that causes the LN resin to uptake lutetium (as well as hafnium, tungsten, and some iron), but not other contaminants, such as copper, lead, zinc, and some iron. The copper, lead, zinc, and iron impurities that are not captured in the LN resin along with the rest of the acid may be directed to a waste container. After the solution is loaded from the dissolution chamber onto the column, subsequent washes of the dissolution chamber may be performed and loaded onto the column as well.

In block 406, both the LN and the DGA columns may be rinsed (e.g., ˜15-20 mL) with hydrochloric acid at a higher concentration (greater than ˜6 M e.g., ˜8 M or higher). Hydrochloric acid at this second acid concentration causes the LN resin to elute lutetium and tungsten while retaining hafnium and iron, and causes the DGA resin in the second column to uptake lutetium and tungsten that were eluted from the LN resin. Trace amounts of copper and lead may be eluted and directed to the waste container with the acid rinse.

In block 408, the second DGA chromatographic column may be rinsed (e.g., up to 10 mL) with hydrochloric acid at a lower third acid concentration (˜2 M) that causes the DGA resin to elute any tungsten impurities while retaining lutetium, thus leaving purified lutetium on the resin.

In block 410, one or multiple of the chromatographic columns may be dried with air or specific gases (e.g., nitrogen) to remove residual hydrochloric acid. This air-drying step may help to maintain a low molarity of hydrochloric acid for the final elution solution in block 412, which may be important for maintaining the purity of the final product and minimizing the volume of acid needed for elution of Lu-177.

In block 412, purified Lu-177 in the form of lutetium chloride (LuCl₃) may be eluted from the DGA resin chromatographic column by rinsing the resin with hydrochloric acid (e.g., ˜5-15 mL) at a fourth acid concentration of up to 0.5 M, such as ˜0.05 M. This low acid concentration causes the DGA resin to elute lutetium, resulting in a lutetium chloride in hydrochloric acid solution that is routed to a collection container. The use of dilute hydrochloric acid for the final elution may provide the lutetium-177 in a chemical form (LuCl₃) suitable for medical use.

Finally, in block 414, the Lu-177 chloride may be packaged for shipment. This step may involve final quality control checks, preparation of the purified lutetium-177 chloride in containers suitable for delivery to end-users, and packaging in shielded containers suitable or approved for shipping radioactive material.

Referring to FIG. 4B, an embodiment purification method 420 based on nitric and hydrochloric acid may use the same configuration of chromatographic columns, with the same or similar amounts of LN resin in the first chromatographic column and DGA resin in the second chromatographic column.

In block 422, the captured lutetium-177 on the collection surface may be dissolved in nitric acid within a dissolution chamber to prepare a load solution. In some embodiments, the nitric acid may have a concentration of ˜8 to 12 M. Again, the dissolution chamber may be part of an integrated purification system as illustrated in FIG. 5.

In block 424, the load solution of nitric acid, dissolved lutetium, and any contaminants may be flowed through both chromatographic columns. In this embodiment, the load solution flows first through the LN ion resin chromatographic column, with the effluent from that column then flowing through the DGA resin chromatographic column. Again, this may be at a controlled flow rate (e.g., ˜1 mL/min.). The load solution may have a first acid concentration of nitric acid in the range of ˜8-12 M at which the LN resin in the first column uptakes hafnium, tungsten, and most iron (˜95%), while the DGA resin in the second column absorbs lutetium and some iron (˜5%). Other impurities, such as copper, lead, and zinc, are not captured in either resin and so may be directed to a waste container. After the solution is loaded from the dissolution chamber onto the two columns, subsequent washes of the dissolution chamber may be performed and loaded onto the columns as well.

In block 426, the second DGA column is rinsed (e.g., ˜15-20 mL) with nitric acid at a second lower acid concentration of about 3 M, which causes the DGA resin to elute the iron absorbed in the initial loading operation in block 424. This leaves purified lutetium nitrate on the DGA resin in the second column.

In block 428, air or specific gases (e.g., nitrogen) may be passed through both columns to remove free-standing liquid, preventing the formation of an acid mixture when hydrochloric acid is introduced into the DGA resin in the next step.

In block 430, the DGA resin chromatographic column may be washed with 11 M hydrochloric acid (e.g., ˜35 mL) to convert lutetium nitrate to lutetium chloride. The acid concentration (third acid concentration) of hydrochloric acid used in this step may be between ˜8 M and ˜12 M is selected to be of sufficient concentration to transform lutetium into the desired final product chemical form.

In block 432, the chromatographic columns (or at least the DGA resin chromatographic column) may be air dried with air or specific gases (e.g., nitrogen) once more to remove residual hydrochloric acid. This second air-drying step may help to maintain a low molarity of hydrochloric acid for the final elution solution in block 412, which may be important for maintaining the purity of the final product.

In block 412, purified Lu-177 chloride may be eluted from the DGA resin chromatographic column by rinsing (e.g., ˜5-15 mL) the resin with hydrochloric acid of a fourth acid concentration of up to 0.5 M (e.g., ˜0.05 M) in the same manner as described with reference to FIG. 4A for the like number block of the method 400.

Finally, in block 414, the Lu-177 chloride may be packaged for shipment in the same manner as described with reference to FIG. 4A for the like-number block of the method 400.

The use of nitric acid for loading and washing, and hydrochloric acid for conversion and elution in the method 420 may take advantage of the different chemical properties of lutetium in nitrate and chloride media to achieve effective separation and purification.

The chemical purification processes outlined in methods 400 and 420 may provide an efficient and effective means of purifying lutetium-177 following electromagnetic isotope separation. By utilizing a combination of carefully selected resins, controlled acid concentrations, and strategic air-drying steps, the processes in the method 400 may yield high-purity lutetium-177 chloride with approximately 90% recovery and minimal to no detectable metallic impurities that is suitable for medical applications.

FIG. 5 illustrates an example arrangement of components of an embodiment of a chemical purification system 502 configured for purifying lutetium-177 chloride following electromechanical separation. The system 502 is suitable for performing the embodiment purification method 420 described with reference to FIG. 4B, although a similar arrangement of valves (or types of valves) and fluid lines may be used to perform the embodiment purification method 400 described with reference to FIG. 4A. The system 502 includes a pump and valve assembly 504, which serves as the central component for directing fluid flows through the chromatographic columns that are used to purify the lutetium-177.

Specifically, the pump and valve assembly 504 includes a first chromatographic column 506 loaded with LN resin, and a second chromatographic column 508 loaded with DGA resin, and a fluid distribution system configured to transfer an acidic solution containing lutetium-177 to the first chromatographic column, deliver acids of different concentrations to the two chromatographic columns, and transfer a purified lutetium-177 chloride solution to a collection vessel. These chromatographic columns facilitate the selective binding and purification of lutetium during the processing stages. The pump and valve assembly 504 further connects to a series of containers 512 through 522, each containing solutions of high resistivity water (HRW) or acids of varying concentrations, such as hydrochloric acid (HCl) or nitric acid (HNO₃), used for dissolution, rinsing, and elution processes as described in the methods 400 and 420. Additionally, the system includes a dissolution chamber 526, where lutetium collected after mass separation is initially dissolved in acid, a waste collection container 528 for receiving waste fluids, and a product receiver container 524 for collecting the purified lutetium chloride. A nitrogen supply 530 is integrated into the system to provide a nitrogen cover gas over the final product in the container 524, preventing oxidation and contamination. Connections to an air supply (not shown) are also provided for venting and drying purposes.

The pump and valve assembly 504 is built around a pump 510 (e.g., a peristaltic pump) equipped with four distinct channels or pipes 532, 534, 536, and 538. These four channels, in conjunction with a plurality of valves 540, enable controlled routing of acid solutions through the system based on valve configurations. The plurality of fluid valves 540 “1” to “14” are coupled to piping and the pump channels so that a first channel is configured to pass an acid through both the first chromatographic column 506 and the second chromatographic column 508, a second channel is configured to transfer the acidic solution containing lutetium-177 to the first chromatographic column 506, a third channel is configured to pass acids of different concentrations through the second chromatographic column 508, a fourth channel is configured to pass dilute hydrochloric acid through the second chromatographic column 508, and the plurality of valves are connected to the plurality of channels and to containers 512 through 522 that are sources of high resistivity water and acids of different types and concentrations, the dissolution chamber 528, and the collection vessel 524. The various valves are positioned, configured, and operable to direct fluids through the fluid distribution system to support the performance of the purification methods described herein.

For example, in the initial dissolution step (block 402 of the method 400), lutetium on a collection surface is dissolved in acid within the dissolution chamber 526. The resulting solution may be diluted and directed through channel 534 of the pump 510 and valve “8” to load the first LN chromatographic column 506 (the operation in block 404). In this loading operation, an additional valve above valve “10” could be added to bypass loading of the DGA resin in the second column 508. As a further example, during the rinse operation (block 406), selected valves are opened to allow a solution of an appropriate concentration of acid (HCl or HNO₃) or HRW from containers 512 through 522 to pass through both chromatographic columns 506 and 508, with valve “11” configured to direct the rinse effluent to the waste collection container 528.

As illustrated in FIG. 6A, subsequent operations of the method 400 involve similar valve and pump operations to pass varying acid concentrations, as well as air, through the columns for the remaining purification stages. Upon completion of the purification process, valve “11” is operated to direct the purified lutetium chloride into the product receiver container 524 in the operation in block 416 of the method 400. Nitrogen from the supply 530 may be introduced into the container 524 to dry the lutetium chloride solution. This system 502 and the configurations and operations of the various valves may allow for precise control of acid concentrations and fluid and gas flow rates throughout the purification process.

The nitric and hydrochloric acid purification process embodiment provides another example of the operation of the pump and valve assembly 504. In this embodiment, the initial dissolution step (block 422 of the method 420) uses concentrated nitric acid (e.g., ˜8-12 M) to dissolve lutetium from the collection surface within the dissolution chamber 526. The resulting solution may be directed through channel 534 of the pump 510 and valves “8” and “10” to load both the first LN chromatographic column 506 and the second DGA chromatographic column 508 in the operation in block 424 of the method 420. At this concentration of nitric acid, hafnium, tungsten, and most of the iron (˜95%) are absorbed in the LN resin, leaving lutetium and a small amount of iron (˜5%) in the solution that flows through the second DGA column, where lutetium and some iron (˜5%) are absorbed by the DGA resin. Copper, lead, and zinc contaminants are not absorbed by either of the LN or DGA resins, and thus are flushed with the nitric acid through valve “11” into the waste container 528.

Continuing this example, during the subsequent elusion operation (block 426), valve “9” is opened, three-way valve “10” set to flow fluid from valve “9” into the column 508, and valve “11” is configured to pass a lower concentration of nitric acid (˜3 M) from containers 518 through channel 536 of the pump 510 through the second chromatographic column 508, with the rinse effluent collecting in the waste collection container 528.

As illustrated in FIG. 6B, subsequent operations of valves and the pump 510 performing the method 420 involve similar valve and pump operations to pass air through the second column 508 to dry the DGA resin between applications of acid (operations 430 and 434), pass hydrochloric acid at high concentration (˜11 M) through the second column 508 in operation 432, and pass hydrochloric acid at low concentration (up to 0.5 M, such as ˜0.05 M) through the second column 508 in elution operation 412. In this final operation, the valve “11” is operated to direct purified lutetium chloride into the product receiver container 524. Nitrogen from the supply 530 is then introduced into the container 524 to evaporate 0.05 M HCl solution to dryness.

The two-column, two-resin purification method of the embodiment using only hydrochloric acid leverages the different uptake and elution characteristics of the LN and DGA resins depending on acid concentration and element chemistry. This is illustrated in FIG. 6A, which shows hydrochloric acid concentrations and fluid flow paths through the two chromatographic columns 506, 508 in this purification process embodiment.

The operations illustrated in FIG. 6A involve four distinct stages of fluid flow and acid concentration adjustments to achieve the desired chemical separation. These stages correspond to the operations in blocks 404, 406, 408, and 416 of the method 400 described above with reference to FIG. 4A.

In the first stage (operation 404), a load solution of ˜0.1 M hydrochloric acid (HCl) solution containing dissolved lutetium-177 and contaminants (flow 602) is introduced into the first column 506, which contains an LN resin. Under this acid concentration, lutetium, hafnium, tungsten, and 50% of the iron are retained by the LN resin, while copper, lead, zinc, and the remaining iron are eluted and directed to the waste container 528.

The second stage (operation 406) involves passing a solution of ˜8 M HCl (flow 604) through both columns 506, 508. When acid of this concentration is introduced, hafnium and iron are retained on the LN resin in the first column 506, while lutetium and tungsten are eluted from the first column and retained by the DGA resin in the second column 508. Any residual copper or lead from the first stage is eluted from the LN resin, flows through the DGA resin, and is directed to the waste container 528.

In the third stage (operation 408), a ˜2 M HCl solution is directed via valve settings to bypass the first column 506 and pass through the DGA resin in the second column 508. A ˜2 M HCl solution causes the DGA to elute tungsten, which is then directed to the waste container 528, while lutetium remains on the DGA resin in the second column 508.

The final stage illustrated in FIG. 6A (operation 412) involves eluting the now purified lutetium-177 chloride from the DGA resin by flowing a low concentration (˜0.05 M) HCl through the resin. Under such low acid concentrations, lutetium is released by the resin, and thus eluted from the second column 508 and collected in the lutetium receiving container 524. This staged approach leverages the varying retention and release characteristics of the resins at different acid concentrations to achieve effective separation of the target elements.

The two-column, two-resin purification methods of various embodiments (i.e., either only HCl or HNO₃/HCl) leverage the different uptake and elution characteristics of the LN and DGA resins depending on nitric and hydrochloric acid concentrations and element chemistry. This is illustrated in FIG. 6B, which shows acid concentrations and fluid flow paths through the two chromatographic columns 506, 508 using the example embodiment in which nitric acid is used initially to dissolve lutetium and load lutetium in the DGA resin followed by using hydrochloric acid convert lutetium nitrate to lutetium chloride and then elute lutetium chloride for collection as a purified product.

The operations illustrated in FIG. 6B involve four distinct stages of fluid flow and acid concentration adjustments to achieve the desired chemical separation. These stages correspond to the operations in blocks 424, 426, 428, and 412 of the method 420 described above with reference to FIG. 4B.

In the first stage (operation 424), a load solution of ˜8-12 M nitric acid (HNO₃) solution containing dissolved lutetium-177 and contaminants (flow 612) is flowed through both the first LN resin column 506 and the second DGA resin column 508 in series. Under this nitric acid concentration, hafnium, tungsten, and approximately 95% of the iron are retained by the LN resin, while lutetium and some (˜5%) iron are absorbed in the DGA resin. Copper, lead, and zinc contaminants are not absorbed by either the LN or DGA resin and are directed to the waste container 528.

The second stage (operation 426) involves passing a solution of ˜3 M nitric acid (flow 614) through the second DGA column 508. When nitric acid of this concentration is introduced, the iron remaining on the DGA resin is eluted and directed to the waste container 528, while lutetium remains retained by the DGA resin in the second column 508.

In the third stage (operation 428), a ˜11-12 M HCl solution is directed via a valve setting (e.g., valves “9” and “10”) to pass through the DGA resin in the second column 508. A ˜11-12 M HCl solution causes the lutetium nitrate retained in the DGA resin to convert to lutetium chloride. This chemical conversion step transforms the lutetium into the chemical form (LuCl₃) of the finished product and enables the final elution step in the fourth stage.

The final stage illustrated in FIG. 6B (operation 412) involves eluting the now purified lutetium-177 chloride from the DGA resin by flowing a low concentration (up to 0.5 M, such as ˜0.05 M) hydrochloric acid through the resin. As described regarding the similar stage illustrated in FIG. 6A, under such a low acid concentration, lutetium is released by the DGA resin, and thus eluted from the second column 508 and collected in the lutetium receiving container 524.

FIG. 6B does not illustrate the air drying operations in blocks 430 and 434 of the method 420, as well as other operations that may be involved in the purification processing of lutetium in various embodiments.

Implementation examples are described in the following paragraphs. While some of the following implementation examples are described in terms of example methods, further example implementations may include: the example methods discussed in the following paragraphs implemented by a computing system including a processing system configured (e.g., with processor-executable instructions) to control operations of the methods of the following implementation examples; and means for performing the function of the various operations.
Example 1: A method of producing purified lutetium-177, including: irradiating a target material containing lutetium-176 in a nuclear reactor; separating lutetium-177 from the irradiated target material using electromagnetic isotope separation; dissolving the separated lutetium-177 in an acidic solution; purifying the dissolved lutetium-177 using two chromatographic columns fluidically coupled in series; and eluting the purified lutetium-177 in a final chemical form suitable for medical use.
Example 2: The method of example 1, in which the target material includes enriched lutetium-176 that is electroplated on a substrate metal.
Example 3: The method of example 2, in which the substrate metal is a mesh or fabric of zirconium wires.
Example 4: The method of any of examples 1-3, in which separating lutetium-177 using electromagnetic isotope separation includes: vaporizing the irradiated target material; ionizing the vaporized material; separating lutetium-177 ions from other ions using electromagnetic fields; and collecting lutetium-177 ions on a collection surface.
Example 5: The method of any of examples 1-4, in which dissolving the lutetium-177 atoms in an acidic solution, includes dissolving the lutetium in hydrochloric acid.
Example 6: The method of example 5, in which purifying the dissolved lutetium-177 using two chromatographic columns fluidically coupled in series includes: passing the dissolved lutetium-177 in low molarity hydrochloric acid (up to 1 M) through the first chromatographic column containing a lanthanide-specific (LN) resin at an acid concentration that causes the LN resin to uptake lutetium but not some metallic contaminants; rinsing the first chromatographic column and a second chromatographic column containing a diglycolamide (DGA) resin with hydrochloric acid at a concentration that causes the LN resin in the first chromatographic column to elute lutetium and causes the DGA resin in the second chromatographic column to uptake lutetium; rinsing the second chromatographic column with hydrochloric acid at a concentration that causes the DGA resin to elute one or more contaminant metals while retaining lutetium; and rinsing the second chromatographic column with hydrochloric acid at a concentration that causes the DGA resin to elute lutetium, yielding purified lutetium-177.
Example 7. The method of any of examples 1-4, in which dissolving the lutetium-177 atoms in an acidic solution includes dissolving the lutetium in nitric acid.
Example 8. The method of example 7, in which purifying the dissolved lutetium-177 using two chromatographic columns fluidically coupled in series includes: passing the dissolved lutetium-177 in a high molarity nitric acid (>6 M) through a first chromatographic column containing a lanthanide-specific (LN) resin and a second chromatographic column containing diglycolamide (DGA) resin at an acid concentration that causes the LN resin to uptake some contaminant metals and the DGA resin to uptake lutetium but not some metallic contaminants; rinsing the second chromatographic column with nitric acid at a concentration that causes the diglycolamide resin to elute one or more contaminant metals while retaining lutetium; rinsing the second chromatographic column with hydrochloric acid at a concentration that converts lutetium nitrate to lutetium chloride on the DGA resin; and rinsing the second chromatographic column with hydrochloric acid at a concentration that causes the DGA resin to elute lutetium, yielding purified lutetium-177.
Example 9. The method of example 8, further including passing air through the chromatographic columns between elution steps to remove residual liquid.
Example 10. A method of purifying lutetium-177, including: dissolving electromagnetically separated lutetium-177 in hydrochloric acid; passing the dissolved lutetium-177 in hydrochloric acid through a first chromatographic column containing a lanthanide-specific (LN) resin at a first acid concentration that causes the LN resin to uptake lutetium but not some metallic contaminants; rinsing in series the first chromatographic column and a second chromatographic column containing a diglycolamide (DGA) resin with hydrochloric acid at a second acid concentration that causes the LN resin in the first chromatographic column to elute lutetium and causes the DGA resin in the second chromatographic column to uptake lutetium; rinsing the second chromatographic column with hydrochloric acid at a third concentration that causes the DGA resin to elute one or more contaminant metals while retaining lutetium; and
rinsing the second chromatographic column with hydrochloric acid at a fourth acid concentration that causes the DGA resin to elute lutetium, yielding purified lutetium-177.
Example 11. The method of example 10, in which the first acid concentration is up to 1 M, the second acid concentration is approximately 8 M, the third acid concentration is approximately 2 M, and the fourth acid concentration is approximately 0.05 M.
Example 12. A method of purifying lutetium-177, including: dissolving electromagnetically separated lutetium-177 in nitric acid; passing the dissolved lutetium-177 in nitric acid first through a first chromatographic column containing a lanthanide-specific (LN) resin and then through a second chromatographic column containing diglycolamide (DGA) resin at a first acid concentration that causes the LN resin to uptake some contaminant metals and the DGA resin to uptake lutetium but not some metallic contaminants; rinsing the second chromatographic column with nitric acid at a second acid concentration that causes the diglycolamide resin to elute one or more contaminant metals while retaining lutetium; rinsing the second chromatographic column with hydrochloric acid at a third acid concentration that converts lutetium nitrate to lutetium chloride on the DGA resin; and
rinsing the second chromatographic column with hydrochloric acid at a fourth acid concentration that causes the DGA resin to elute lutetium, yielding purified lutetium-177.
Example 13. The method of example 12, in which first acid concentration is 6 M or greater, the second acid concentration is approximately 3 M, the third concentration is approximately 11 to 12 M, and the fourth acid concentration is approximately 0.05 M.
Example 14. The method of example 12, further including passing air through the first and second chromatographic columns between elution steps to remove residual liquid.
Example 15. A system for purifying lutetium-177, including: an electromagnetic isotope separator configured to separate lutetium-177 from other isotopes in the irradiated target material; and a chemical purification system, including: a dissolution chamber configured to dissolve the separated lutetium-177 in an acidic solution; a series of chromatographic columns including a first chromatographic column and a second chromatographic column fluidically coupled in series; a collection vessel configured to receive a purified lutetium-177 chloride solution from the second chromatographic column; and a fluid distribution system configured to transfer an acidic solution containing lutetium-177 to the series of chromatographic columns, delivers acids of different concentrations to the series of chromatographic columns in a manner that separates lutetium from contaminants, and transfers the purified lutetium-177 chloride solution to the collection vessel.
Example 16. The system of example 15, in which: the first chromatographic column contains a lanthanide-specific resin; and the second chromatographic column contains a diglycolamide resin.
Example 17. The system of example 16, in which the fluid distribution system includes: a plurality of fluid valves coupled to piping; and a pump configured with a plurality of channels, in which: a first channel is configured to transfer the acidic solution to the dissolution chamber and a second channel pumps the dissolution solution containing lutetium-177 to one or both of the first chromatographic column and the second chromatographic column; a third channel is configured to pass acids of different concentrations through the second chromatographic column; a fourth channel is configured to pass dilute hydrochloric acid through the second chromatographic column; and
the plurality of valves are connected to the plurality of channels and to sources of acids, the dissolution chamber, and the collection vessel and operable to direct fluids through the fluid distribution system.
Example 18. The system of example 17, further including: a source of nitrogen fluidically coupled to the collection vessel.
Example 19. The system of example 18, further including a source of air coupled to one of the plurality of valves that is operable to pass air through one or both of the first and second chromatographic columns.
Example 20. The system of example 19, further including a waste fluid receiving container configured to receive fluids from the first and second chromatographic columns other than the purified lutetium-177 chloride solution.

Further embodiments include a system for producing purified lutetium-177 that includes means for separating lutetium-177 from an irradiated target material using electromagnetic isotope separation (e.g., electromagnetic isotope separator, step 110), means for dissolving the separated lutetium-177 in an acidic solution (e.g., dissolution chamber, block 402), means for purifying the dissolved lutetium-177 using a series of chromatographic columns (e.g., LN column, DGA column, steps 404-414), and means for eluting the purified lutetium-177 in a final chemical form suitable for medical use (e.g., collection vessel, steps 416-418).

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

References to particular approximate acid concentrations, volumes, fluid flow rates are intended as enabling but not limiting examples. For example, the acid-concentration-dependent uptake or elution rates of lutetium and various contaminants by LN and DGA resins may vary based on the type or supplier of the resins. Further, the described purification operations may be accomplished using acids in concentrations that differ from the approximate concentrations described in the foregoing examples. Therefore, the example concentrations, volumes, fluid flow rates of acids and mixtures described herein are for illustration purposes and not intended to limit the scope of the claims unless recited in the claims.

The foregoing method descriptions and the process flow diagrams are provided merely as illustrative examples and are not intended to require or imply that the operations of various embodiments must be performed in the order presented. As will be appreciated by one of skill in the art, the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

We claim:

1. A method of producing purified lutetium-177, comprising:
irradiating a target material containing lutetium-176 in a nuclear reactor;
separating lutetium-177 from the irradiated target material using electromagnetic isotope separation;
dissolving the separated lutetium-177 in an acidic solution;
purifying the dissolved lutetium-177 using two chromatographic columns fluidically coupled in series; and
eluting the purified lutetium-177 in a final chemical form suitable for medical use.

2. The method of claim 1, wherein the target material comprises enriched lutetium-176 that is electroplated on a substrate metal.

3. The method of claim 2, wherein the substrate metal is a mesh or fabric of zirconium wires.

4. The method of claim 1, wherein separating lutetium-177 using electromagnetic isotope separation comprises:
vaporizing the irradiated target material;
ionizing the vaporized material;
separating lutetium-177 ions from other ions using electromagnetic fields; and
collecting lutetium-177 ions on a collection surface.

5. The method of claim 1, wherein dissolving the lutetium-177 atoms in an acidic solution comprises dissolving the lutetium in hydrochloric acid.

6. The method of claim 1, wherein purifying the dissolved lutetium-177 using two chromatographic columns fluidically coupled in series comprises:
passing the dissolved lutetium-177 in low molarity hydrochloric acid (up to 1 M) through the first chromatographic column containing a lanthanide-specific (LN) resin at an acid concentration that causes the LN resin to uptake lutetium but not some metallic contaminants;
rinsing the first chromatographic column and a second chromatographic column containing a diglycolamide (DGA) resin with hydrochloric acid at a concentration that causes the LN resin in the first chromatographic column to elute lutetium and causes the DGA resin in the second chromatographic column to uptake lutetium;
rinsing the second chromatographic column with hydrochloric acid at a concentration that causes the DGA resin to elute one or more contaminant metals while retaining lutetium; and
rinsing the second chromatographic column with hydrochloric acid at a concentration that causes the DGA resin to elute lutetium, yielding purified lutetium-177.

7. The method of claim 1, wherein dissolving the lutetium-177 atoms in an acidic solution comprises dissolving the lutetium in nitric acid.

8. The method of claim 7, wherein purifying the dissolved lutetium-177 using two chromatographic columns fluidically coupled in series comprises:
passing the dissolved lutetium-177 in a high molarity nitric acid (>6 M) through a first chromatographic column containing a lanthanide-specific (LN) resin and a second chromatographic column containing diglycolamide (DGA) resin at an acid concentration that causes the LN resin to uptake some contaminant metals and the DGA resin to uptake lutetium but not some metallic contaminants;
rinsing the second chromatographic column with nitric acid at a concentration that causes the diglycolamide resin to elute one or more contaminant metals while retaining lutetium;
rinsing the second chromatographic column with hydrochloric acid at a concentration that converts lutetium nitrate to lutetium chloride on the DGA resin; and
rinsing the second chromatographic column with hydrochloric acid at a concentration that causes the DGA resin to elute lutetium, yielding purified lutetium-177.

9. The method of claim 8, further comprising passing air through the chromatographic columns between elution steps to remove residual liquid.

10. A method of purifying lutetium-177, comprising:
dissolving electromagnetically separated lutetium-177 in hydrochloric acid;
passing the dissolved lutetium-177 in hydrochloric acid through a first chromatographic column containing a lanthanide-specific (LN) resin at a first acid concentration that causes the LN resin to uptake lutetium but not some metallic contaminants;
rinsing in series the first chromatographic column and a second chromatographic column containing a diglycolamide (DGA) resin with hydrochloric acid at a second acid concentration that causes the LN resin in the first chromatographic column to elute lutetium and causes the DGA resin in the second chromatographic column to uptake lutetium;
rinsing the second chromatographic column with hydrochloric acid at a third concentration that causes the DGA resin to elute one or more contaminant metals while retaining lutetium; and
rinsing the second chromatographic column with hydrochloric acid at a fourth acid concentration that causes the DGA resin to elute lutetium, yielding purified lutetium-177.

11. The method of claim 10, wherein the first acid concentration is up to 1 M, the second acid concentration is approximately 8 M, the third acid concentration is approximately 2 M, and the fourth acid concentration is approximately 0.05 M.

12. A method of purifying lutetium-177, comprising:
dissolving electromagnetically separated lutetium-177 in nitric acid;
passing the dissolved lutetium-177 in nitric acid first through a first chromatographic column containing a lanthanide-specific (LN) resin and then through a second chromatographic column containing diglycolamide (DGA) resin at a first acid concentration that causes the LN resin to uptake some contaminant metals and the DGA resin to uptake lutetium but not some metallic contaminants;
rinsing the second chromatographic column with nitric acid at a second acid concentration that causes the diglycolamide resin to elute one or more contaminant metals while retaining lutetium;
rinsing the second chromatographic column with hydrochloric acid at a third acid concentration that converts lutetium nitrate to lutetium chloride on the DGA resin; and
rinsing the second chromatographic column with hydrochloric acid at a fourth acid concentration that causes the DGA resin to elute lutetium, yielding purified lutetium-177.

13. The method of claim 12, wherein first acid concentration is 6 M or greater, the second acid concentration is approximately 3 M, the third concentration is approximately 11 to 12 M, and the fourth acid concentration is approximately 0.05 M.

14. The method of claim 10, further comprising passing air through the first and second chromatographic columns between elution steps to remove residual liquid.

15. A system for purifying lutetium-177, comprising:
an electromagnetic isotope separator configured to separate lutetium-177 from other isotopes in the irradiated target material; and
a chemical purification system, comprising:
a dissolution chamber configured to dissolve the separated lutetium-177 in an acidic solution;
a series of chromatographic columns comprising a first chromatographic column and a second chromatographic column fluidically coupled in series;
a collection vessel configured to receive a purified lutetium-177 chloride solution from the second chromatographic column; and
a fluid distribution system configured to transfer an acidic solution containing lutetium-177 to the series of chromatographic columns, delivers acids of different concentrations to the series of chromatographic columns in a manner that separates lutetium from contaminants, and transfers the purified lutetium-177 chloride solution to the collection vessel.

16. The system of claim 15, wherein:
the first chromatographic column contains a lanthanide-specific resin; and
the second chromatographic column contains a diglycolamide resin.

17. The system of claim 16, wherein the fluid distribution system comprises:
a plurality of fluid valves coupled to piping; and
a pump configured with a plurality of channels, wherein:
a first channel is configured to transfer acid to the dissolution chamber to dissolve lutetium-177 from the substrate and to pass an acid through one or both of the first chromatographic column and the second chromatographic column;
a second channel is configured to transfer the acidic solution containing lutetium-177 to one or both of the first chromatographic column and the second chromatographic column;
a third channel is configured to pass acids of different concentrations through the second chromatographic column;
a fourth channel is configured to pass dilute hydrochloric acid through the second chromatographic column; and
the plurality of valves are connected to the plurality of channels and to sources of acids, the dissolution chamber, and the collection vessel and operable to direct fluids through the fluid distribution system.

18. The system of claim 17, further comprising:
a source of nitrogen fluidically coupled to the collection vessel.

19. The system of claim 18, further comprising a source of air coupled to one of the plurality of valves that is operable to pass air through one or both of the first and second chromatographic columns.

20. The system of claim 19, further comprising a waste fluid receiving container configured to receive fluids from the first and second chromatographic columns other than the purified lutetium-177 chloride solution.
